(19) United States
(12) Patent Application Publication
(10) Pub. No.: US 2002/0195299 A1
(43) Pub. Date: Dec. 26, 2002

(54) Stroller brake with supporting function

(76) Inventor: Ying-Hsiung Cheng, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/888,563

(22) Filed: Jun. 26, 2001

(51) Int. Cl. B62B 9/08; B62B 1/00

(52) U.S. Cl. 188/20; 280/647

(57) ABSTRACT

A stroller brake with supporting function has a main body, a control pedal and an engaging rod. The control pedal is connected to an upper edge of the main body. The engaging rod is secured to a lower part of the main body. The main body is pivoted to a lower end of a rear wheel connecting member from an upper part so that it can be moved between a locking position where first holes of the main body engages lateral positioning protrusions of the rear wheel connecting member and where the engaging rod engages engaging rooms of the rear wheel and an unlocking position where second holes engages the lateral positioning protrusions to keep the engaging rod engage off the engaging rooms. When the stroller is folded, and the brake moved to the locking position, the stroller can be supported in an upright position by the rear wheels and the brakes.

### BACKGROUND OF THE INVENTION

The present invention relates to a stroller brake, and particularly to one which can help the rear wheels of the stroller to support the stroller in an upright position after the stroller is folded to a compact size.

Most strollers are made to be foldable so that they can be folded to a compact size for easy storage when not used. However, some of them have the front wheels disposed higher than the rear wheels in the folded position, not able to stand. And, the user has to lay them on the ground, causing the folded stroller to take up much space. The others of them have the front wheels disposed as high as the rear wheels in the folded position to be able to stand on the ground. However, they are likely to unwantedly move because they are supported by wheels.

### SUMMARY OF THE INVENTION

Therefore, it is a main object of the present invention to provide a stroller with a means which can help the wheels of the stroller to support the stroller in an upright position when the stroller is folded to a compact size, and prevent the folded stroller from unwantedly moving.

The supporting means of the present invention includes a main body, an engaging rod part and a control pedal. The main body is pivoted to a connecting member formed on a lower end of a rear wheel support rod.

The engaging rod part is provided at a lower part of the main body. And, the control pedal is connected to an upper edge of the main body. The control pedal is pressed to pivot the main body between a locking position where first holes on the main body engage lateral positioning protrusions of the connecting member and an unlocking position where second holes engage the positioning protrusions and the engaging rod part is kept off the engaging rooms of the rear wheel.

When the stroller is folded, and the brake moved to the locking position, the stroller can be stably supported in an upright position by the rear wheels and the brake.

### BRIEF DESCRIPTION OF THE DRAWINGS

This invention will be better understood by referring to the accompanying drawings, wherein:

FIG. 1 is a fragmentary exploded perspective view of the stroller with the brake having supporting function according to the present invention.

FIG. 2 is a side view of the brake with supporting function of the present invention and the related parts.

FIG. 3 is a side view of the stroller with the brake having supporting function of the present invention under a folded and standing position.

FIG. 4 is a side view of the brake with supporting function of the present invention and the related parts.

### DETAILED DESCRIPTION OF THE PREFERRED EMBODIMENT

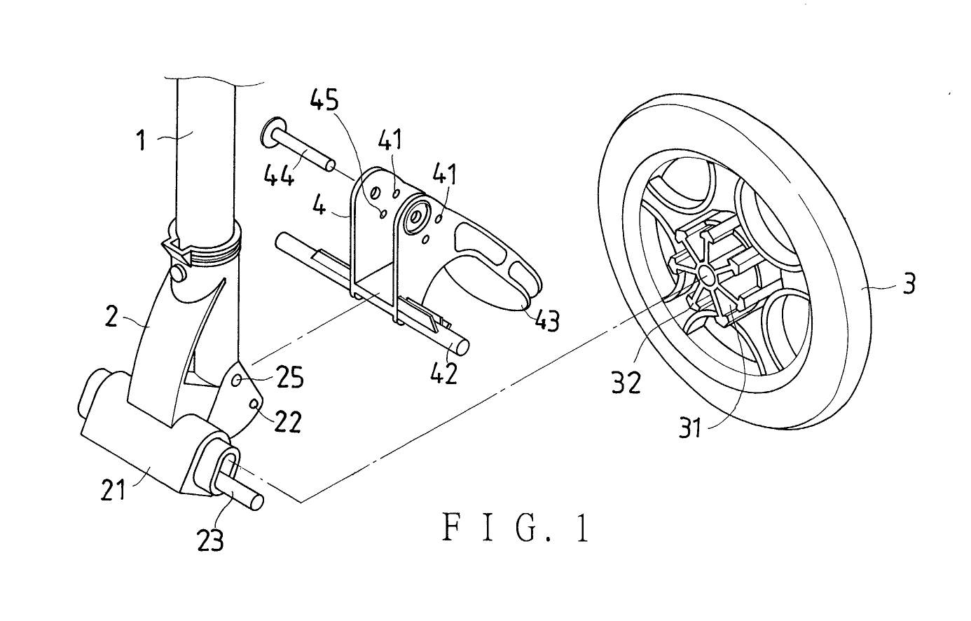

Referring to FIG. 1, a stroller brake 4 with supporting function according to the present invention includes a main body having two parallel lateral walls (not numbered), a control pedal 43 connected to the edges of both of the lateral walls, an engaging rod part 42 connected to lower end portions of the lateral walls.

The lateral walls tapers off towards the upper ends, and each has a first hole 41 and a second hole 45; the two first holes 41 are aligned, and the two second holes 45 are also aligned.

A rear support rod 1 of the stroller has a connecting member 2 at the lower end. The connecting member 2 includes an axle support 21, an axle 23 passing through the axle support 21, a through hole 25, and a pair of positioning protrusions 22 each formed on one side of the connecting member 2.

A rear wheel of the stroller has two wheel parts 3; the parts 3 are each connected to one end portion of the axle 23, and each has radially disposed engaging blades 32 around the central hole. Engaging rooms 31 form between every adjacent two of the engaging blades 32. The blades 32 stick out from the inner side of the wheel parts 3.

The brake 4 is pivoted to the through hole 25 of the connecting member 2 by means of passing a pivotal rod 44 through the holes 25 and the lateral walls thereof.

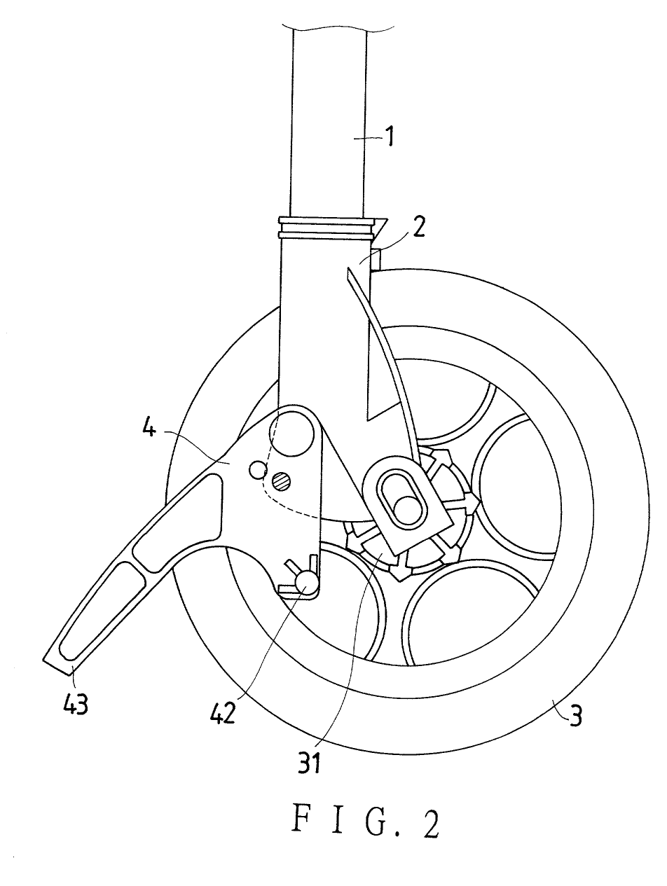

Thus, the brake 4 can be pivoted between a not-in-use position where the second holes 45 engage a corresponding one of the positioning protrusions 25 of the connecting member 2 and an in-use locking position where the first holes 41 engage the positioning protrusions 25. When the brake 4 is at the not-in-use position, the engaging rod part 42 is kept off the engaging rooms 31 to not stop the wheel from turning as shown in FIG. 2. The control pedal 43 is pressed to move the engaging rod part 42 for same to pass into the engaging rooms 31 so that the stroller can be stopped.

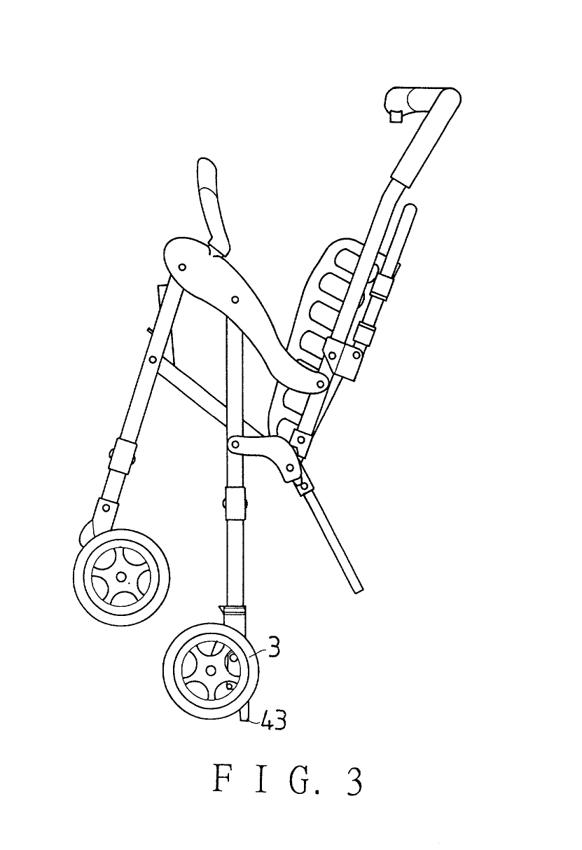

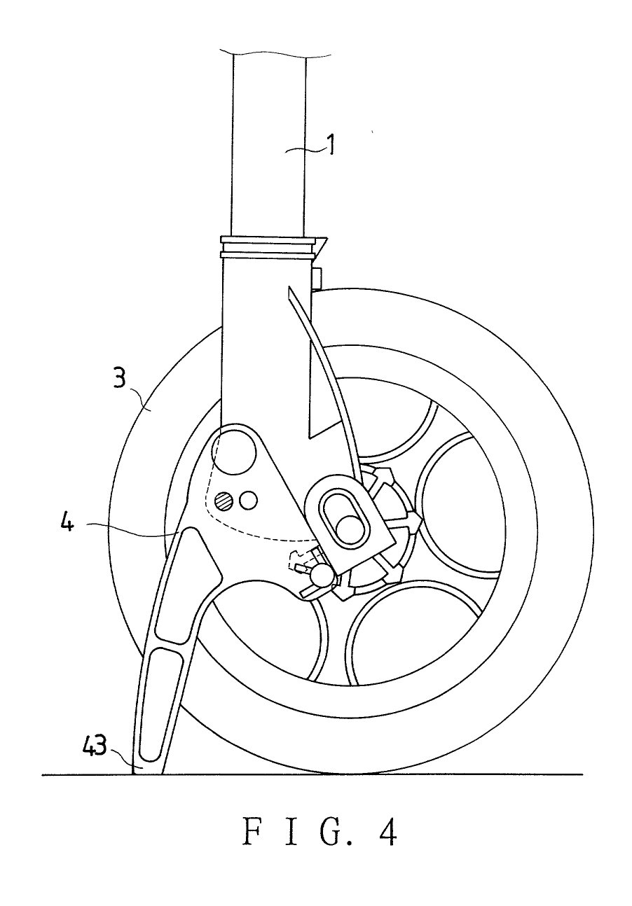

When the stroller is moving in a folded position, and the control pedal 43 is pressed for the brake 4 to move to the in-use locking position, the engaging rod part 42 will engage the engaging rooms 31 to prevent the rear wheel parts 3 from turning as shown in FIGS. 3 and 4.

Referring to FIG. 3, the stroller in a folded position has the front wheels being disposed higher than the rear wheels, and the brake 4 being disposed in the locking position to prevent the rear wheel from turning. Therefore, the stroller can be stably supported in an upright position by the rear wheels and the brake 4.

From the above description, we can know that the stroller brake of the present invention can work as both a brake and a supporting means for permitting the folded stroller to stand stably in an upright position.

What is claimed is:

1. A stroller brake with supporting function, comprising
a main body pivoted to a connecting member formed on a lower end of a rear wheel support rod;
said main body having first holes and second holes;
an engaging rod part secured to a lower part of said main body;
a control pedal at other side of said engaging rod part; said control pedal pressed to pivot said main body between a not-in-use position where said second holes engage positioning protrusions of said connecting member, and where said engaging rod part is kept off engaging rooms of one of rear wheels turnably connected to said connecting member and an in-use locking position where said first holes engage said positioning protrusions, and where said engaging rod part engages said engaging rooms of said rear wheel to prevent said rear wheel from turning;
whereby said stroller can be supported in an upright position by said rear wheel of said kind and said brake positioned at said locking position when same is folded for storage.
